(19) United States
(12) Patent Application Publication
(10) Pub. No.: US 2010/0230575 A1
(43) Pub. Date: Sep. 16, 2010

(54) MOULD ELECTRIC HEATING AND AIR COOLING SYSTEM

(76) Inventor: Gabriel MIRONOV, Montreal (CA)

Correspondence Address: MORRISON & FOERSTER, LLP, 555 WEST FIFTH STREET, SUITE 3500, LOS ANGELES, CA, 90013-1024, US

(21) Appl. No.: 12/538,095

(22) Filed: Aug. 7, 2009

(30) Foreign Application Priority Data
Mar. 13, 2009 (CN) 200920006581.4

(51) Int. Cl. B28B 7/42

(52) U.S. Cl. 249/78

(57) ABSTRACT

The present invention relates to a mould electric heating and air cooling system, especially to such a system for large composite moulds, e.g. wind turbine blade moulds. Particularly, the present invention provides a mould electric heating and air cooling system used in a mould configuring the sandwich type consisting of a first mould shell incorporating a working surface in the front side thereof, a second mould shell and a core layer inserting between the back side of the first mould shell and the front side of the second mould shell, in which the system comprises electric heating means and air cooling means. With the present system, it is possible to obtain both accurate heating control and prompt cool down of the mould.

### FIELD OF INVENTION

The present invention relates to a mould electric heating and air cooling system, especially to the mould electric heating and air cooling system for large composite moulds, e.g. wind turbine blade moulds.

### BACKGROUND OF THE INVENTION

Wind turbine blade producers have used electric mould heating for some time, and the use of the electric resistance wires within the mould shell is widely accepted. However, existing electric heating system do not provide any method to achieve effective and rapid cooling down of the mould after the blade is removed, or to cool the mould in case of overheating during the moulding process.

Wind turbine blade producers have used air heating and cooling of the moulds for some time. Such method allows quick heating and cooling, however the users of air heating are unable to obtain precise and equal control of the mould temperature. They typically attempt to manipulate the airflow using ducts and doors, but this cannot achieve the precision heating that is possible using electric resistance.

### SUMMARY OF THE INVENTION

The present invention aims to provide a mould electric heating and air cooling system to obtain both accurate heating control and prompt cool down.

In order to achieve the above aim, the present invention provides a mould electric heating and air cooling system used in a mould configuring the sandwich type consisting of a first mould shell incorporating a working surface in the front side, a second mould shell and a core layer inserting between the back side of the first mould shell and the front side of the second mould shell, in which the system comprises electric heating means and air cooling means.

Preferably, the electric heating means is arranged in the first mould shell and the air cooling means is arranged in the core layer and the second mould shell.

Preferably, the electric heating means consist of heating wires.

Preferably, the electric heating means also include heating sensors and overheating detection switches.

Preferably, the heating power applied to the heating wires is between 100 and 5000 W/m².

Preferably, the air flow medium consists of aluminum honeycomb with perforated through holes.

Optionally, composite or metallic ‘C’ or ‘U’ channels may be used as an alternative core material.

Preferably, the first mould shell is formed by resin infusion process, using epoxy or vinyl ester resin with fiberglass or carbon fiber.

Preferably, the second mould shell is formed by hand lamination and vacuum bagging, or by using prepreg.

Preferably, the first mould shell thickness is equal to, or greater than that of the second mould shell.

When the mould needs to be heated, current is applied to the heating wires, so precise and equal control of the mould temperature can be obtained. While the mould needs to be cooled, cooling air from the cooling air supply equipment is provided into the core layer via some of the through holes, flowing in the channels or the air flow perforations, and discharged out of the core layer via the other through holes with heat of the mould. Thus the mould can be cooled down effectively and rapidly.

Optionally, during the ramping up and constant temperature holding phases of production, air may be circulated through the mould core in order to help balance the mould temperature in the root area of the blade or other areas where local overheating may occur due to the resin exotherm.

### BRIEF DESCRIPTION OF THE DRAWINGS

FIG. 1 is a section view of the mould electric heating and air cooling system, showing the sandwich construction of the mould;

FIG. 2 is a view of the system seeing from direction Y in FIG. 1, showing through holes in the second mould shell;

FIG. 3 is another section view of the system seeing from direction X in FIG. 1, showing the C or U shaped channels in the core layer; and

FIG. 4 is a view similar to FIG. 3, showing the alternative embodiment of the channels in FIG. 3.

### DETAILED DESCRIPTION OF THE INVENTION

Hereinafter a preferred embodiment of the present invention will be described with reference to the drawings.

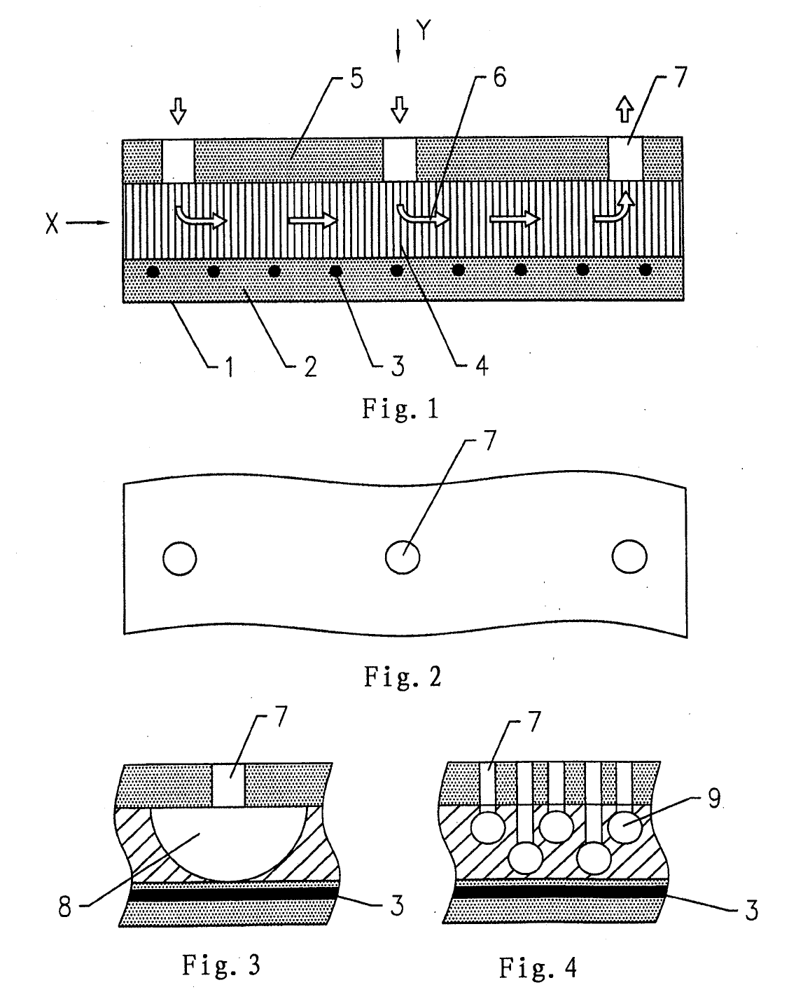

FIGS. 1-3 illustrate an embodiment of the mould electric heating and air cooling system of the invention used in a mould. In which FIG. 1 is a section view of the system, showing the sandwich construction of the mould; FIG. 2 is a view of the system seeing from direction Y in FIG. 1, showing through holes 7 in the second mould shell; and FIG. 3 is another section view of the system in direction X in FIG. 1, showing the C or U shaped channels in the core layer.

As shown in FIG. 1, the mould has a sandwich construction consisting of the first mould shell 2, the second mould shell 5 and the core layer 4 interposing between the first mould shell 2 and the second mould shell 5.

The first mould shell 2 is a composite lamination which is formed by resin infusion process, using epoxy or vinyl ester resin with fiberglass or carbon fiber. The front surface (the underside surface in FIG. 1) of the first mould shell 2 is the working surface 1 of the mould. The heating wires 3 are installed according to the heating plan directly in heating zones of the first mould shell 2. The heating zones are, for example, 1-5 m² in size. The heating power can be provided among 100-5000 W/m². Heating sensors and overheating detection switches are also installed in the first mould shell 2 if necessary.

The core layer is made from fiberglass, aluminum or the like. It is bonded between the back surface (upper surface in FIG. 1) of the first mould shell 2 and the front surface (underside surface in FIG. 1) of the second mould shell 5 and configured for the cooling air to pass therethrough in the direction 6 (FIG. 1). For example, the core layer 4 includes corrugated passages 9 composing of channels 8 or C or U shape in section perpendicular to the axis of the corrugated passages 9. The corrugated passages 9 and the C or U shaped channels 8 can be seen from FIGS. 1 and 3. Alternatively, as shown in FIG. 4, the core layer 4 for cooling air flow is formed from materials with a plurality of air flow perforations 10 parallel to each other. The air flow perforations 10 may be arranged, for example, in a honeycomb pattern when viewed from direction Y, that is, as viewed from the front or back surface direction.

The second mould shell 5 is formed by hand lamination and vacuum bagging or by using prepreg. A plurality of through holes 7 are drilled from the back surface (upper surface in FIG. 1) of the second mould shell 5. The arrangement of the through holes 7 can be seen from FIG. 2. As shown in FIG. 3 and FIG. 4, each of the through holes 7 is communicated with one of the corrugated passages 9 or the air flow perforations 10 for inducing or expelling the cooling air to pass the core layer 4.

Additionally, though not illustrated in the Figs, a cooling air supply equipment of the common type is provided to the system as a cooling air resource and is connected to the through holes 7 in the second mould shell 5 by flexible tubes or other ducts (omitted in the Fig).

In a particularly preferred embodiment, the first mould shell 2 and the second mould shell 5 are of similar thickness and lamination design, in order to obtain overall thermal symmetry of the system and to prevent warping during heating and cooling.

The mould electric heating and air cooling system operates in the following way. When the mould needs to be heated, current is applied to the heating wires 3, so precise and equal control of the mould temperature can be obtained. While the mould needs to be cooled, cooling air from the cooling air supply equipment is provided into the core layer 4 via some of the through holes 7, flowing in the corrugated passage 9 or the air flow perforations 10, and discharged out of the core layer 4 via the other through holes 7 with heat of the mould. Thus the mould can be cooled down effectively and rapidly.

The invention described above may be modified and adapted without thereby departing from the scope of the invention concept. For example, the composite lamination of the mould shells can be made by using prepreg, substitution of hand lamination and infusion. Obviously, in practice modifications and/or improvements are all coved by the claims herein.

What is claimed is:

1. A mould electric heating and air cooling system used in a mould configuring the sandwich type consisting of a first mould shell incorporating a working surface in the front side thereof, a second mould shell and a core layer inserting between the back side of the first mould shell and the front side of the second mould shell, in which the system comprises electric heating means and air cooling means.

2. The mould electric heating and air cooling system according to claim 1, in which the electric heating means is arranged in the first mould shell and the air cooling means is arranged in the core layer and the second mould shell.

3. The mould electric heating and air cooling system according to claim 2, in which the electric heating means consist of heating wires.

4. The mould electric heating and air cooling system according to claim 3, in which the electric heating means also include heating sensors and overheating detection switches.

5. The mould electric heating and air cooling system according to claim 3, in which the heating power applied to the heating wires is between 100 and 5000 W/m².

6. The mould electric heating and air cooling system according to claim 2, in which the air cooling means consist of at least one air path in the core layer and more than one through holes in the second mould shell each communicating with one of the air paths.

7. The mould electric heating and air cooling system according to claim 6, in which the air path comprises at least one corrugated passage composing of a plurality of channels of C or U shape in section perpendicular to the axis of the corrugated passages.

8. The mould electric heating and air cooling system according to claim 6, in which the air path comprises a plurality of air flow perforations arranged parallel to each other.

9. The mould electric heating and air cooling system according to claim 8, in which the air flow perforations penetrate a metallic honeycomb core material.

10. The mould electric heating and air cooling system according to claim 6, in which at least some of the through holes in the second mould shell arrange adjacent each edge of the mould in air flow direction within the core layer.

11. The mould electric heating and air cooling system according to claim 6, in which a cooling air supply device is connected to the through holes via flexible tubes or ducts.

12. The mould electric heating and air cooling system according to any one of claims 1-11, in which the core layer is made of aluminum, fiberglass or the like.

13. The mould electric heating and air cooling system according to any one of claims 1-11, in which the first mould shell is formed by resin infusion process, using epoxy or vinyl ester resin with fiberglass or carbon fiber.

14. The mould electric heating and air cooling system according to any one of claims 1-11, in which the second mould shell is formed by hand lamination and vacuum bagging.

15. The mould electric heating and air cooling system according to any one of claims 1-11, in which the second mould shell is formed by using prepreg.

16. The mould electric heating and air cooling system according to any one of claims 1-11, in which the first mould shell and the second mould shell are of similar thickness and lamination construction.
